(19) United States
(12) Patent Application Publication
(10) Pub. No.: US 2025/0148764 A1
(43) Pub. Date: May 8, 2025

(54) IMAGE PROCESSING APPARATUS, IMAGE PROCESSING METHOD, AND COMPUTER-READABLE RECORDING MEDIUM

(71) Applicant: NEC Corporation, Tokyo (JP)

(72) Inventor: Youki SADA, Tokyo (JP)

(73) Assignee: NEC Corporation, Tokyo (JP)

(21) Appl. No.: 18/937,189

(22) Filed: Nov. 5, 2024

(30) Foreign Application Priority Data
Nov. 7, 2023 (JP) 2023-190300

(51) Int. Cl. G06V 10/77; G06V 10/26

(52) U.S. Cl. CPC G06V 10/7715; G06V 10/26

(57) ABSTRACT

An image processing apparatus comprising a plurality of sparse transformer units, wherein the sparse transformer units each includes: an extraction unit that: uses a matrix formed such that a plurality of first feature vectors and a matrix formed such that a plurality of second feature vectors to calculate, the difference between the first feature vector and the second feature vector; and, based on the difference, extracts a feature vector that is a computation target; and a transformer processing unit that includes a plurality of matrix multipliers, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

### CROSS-REFERENCE TO RELATED APPLICATION

This application is based upon and claims the benefit of priority from Japanese patent application No. 2023-190300, filed on Nov. 7, 2023, the disclosure of which is incorporated herein in its entirety by reference.

### BACKGROUND OF THE INVENTION

### 1. Field of the Invention

The present disclosure relates to an image processing apparatus, an image processing method, and a computer-readable recording medium for executing image processing at high speed.

### 2. Background Art

The Vision Transformer (ViT) is known as a model for executing image recognition processing using a Transformer (deep learning model) used in the field of natural language processing.

As a related technique, Patent Document 1 (Japanese Patent Laid-Open Publication No. 2023-092206) discloses an image processing apparatus in which feature extraction performance is improved by multitask learning using a feature extractor in which a Transformer is used. The image processing apparatus disclosed in Patent Document 1 generates a plurality of partial images by splitting an image including an object. Next, the image processing apparatus converts the partial images obtained by the splitting into tokens, each of which is a vector having a fixed number of dimensions, and adds, to the sequence of tokens obtained by the conversion, a class token having a fixed number of dimensions corresponding to the fixed number of dimensions of the tokens. Next, the image processing apparatus updates the sequence of tokens to which the class token has been added based on the relevance between the tokens, and extracts a feature amount of the object from an encoded expression corresponding to the updated class token. Furthermore, the image processing apparatus determines an attribute of the object from the encoded expression corresponding to the updated class token.

However, according to the above-described image processing in which ViT is used, the amount of computation increases and processing time increases accordingly should high-resolution tasks such as practical object detection and pose estimation be processed.

### SUMMARY OF THE INVENTION

An example object of the present disclosure is to reduce the processing time of image processing in which ViT is used.

In order to achieve the example object described above, an image processing apparatus according to an example aspect of the present disclosure includes:
the image processing apparatus comprising a plurality of sparse transformer units,
wherein the sparse transformer units each comprise:
   an extraction unit that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
   a transformer processing unit that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

Also, in order to achieve the example object described above, an image processing method according to an example aspect of the present disclosure includes:
the image processing method in which an image processing apparatus executes a plurality of sparse transformer processes,
wherein the sparse transformer processes each execute:
   an extraction process that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
   a transformer process that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

Furthermore, in order to achieve the example object described above, a computer-readable recording medium according to an example aspect includes a program recorded on the computer-readable recording medium, the program including instructions that cause the computer to carry out:
the computer readable recording medium that includes a program recorded thereon,
wherein the program causes a computer to execute a plurality of sparse transformer processes, and
the sparse transformer processes each execute:
   an extraction process that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
   a transformer process that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

As described above, according to the present disclosure, it is possible to it is reduce the processing time of image processing in which ViT is used.

### BRIEF DESCRIPTION OF THE DRAWINGS

FIG. 1 is a diagram for describing an example of a conventional image processing apparatus.

FIG. 2 is a diagram for describing an example of a conventional transformer processing unit.

FIG. 3 is a diagram for describing an example of a sparse transformer unit.

FIG. 4 is a diagram illustrating an example of a system including the image processing apparatus.

FIG. 5 is a diagram for describing an example of a configuration of a sparse transformer unit.

FIG. 6 is a diagram for describing an example of an extraction unit (method (1)).

FIG. 7 is a diagram for describing an example of a configuration of a sparse transformer unit.

FIG. 8 is a diagram for describing an example of an extraction unit (method (2)).

FIG. 9 is a diagram for describing sparse attention in method (1).

FIG. 10 is a diagram for describing sparse attention in method (2).

FIG. 11 is a diagram for describing the image processing apparatus.

FIG. 12 is a diagram for describing an example of a computer that realizes the image processing apparatus in the example embodiment.

### EXEMPLARY EMBODIMENT

First, an overview will be provided to facilitate understanding of the example embodiment to be described in the following.

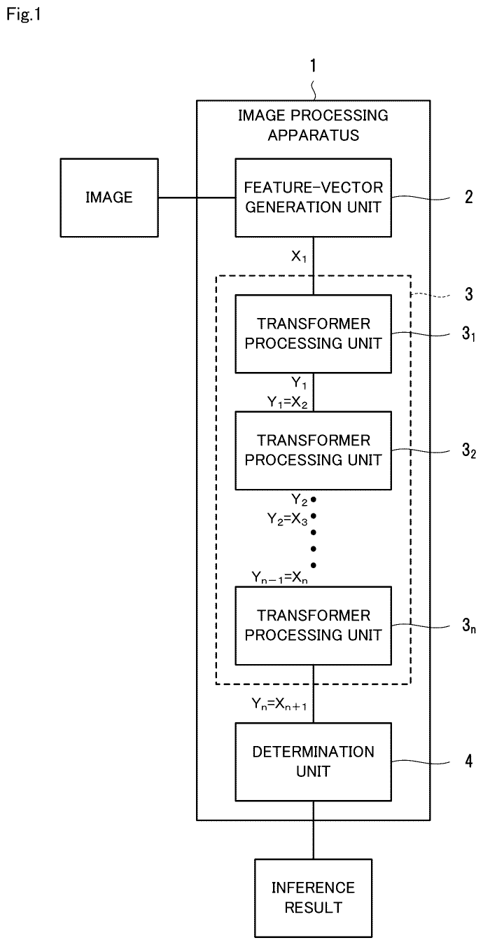

FIG. 1 is a diagram for describing an example of a conventional image processing apparatus. An image processing apparatus 1 illustrated in FIG. 1 is an apparatus that performs object detection, pose estimation, or the like, for example, using ViT. Note that, for the details of ViT, reference is to be made to Reference Document [1].

[1] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, Jakob Uszkoreit, Neil Houlsby, “An Image is Worth 16×16 Words: Transformers for Image Recognition at Scale”, [online], Published: 13 Jan. 2021, Last Modified: 17 Sep. 2023, International Conference on Learnin Representations ICLR 2021, [Retrieved on 27 Sep. 2023], Internet <URL: https://openreview.net/forum?id=YicbFdNTTy>

The image processing apparatus 1 includes a feature-vector generation unit 2, transformer processing units 3 (3₁, 3₂, . . . 3ₙ; a plurality of layers), and a determination unit 4. Note that n is a positive integer of 3 or greater. In practice, several hundred transformer processing units 3 or more are arranged, for example. Furthermore, each transformer processing unit 3 is a conventional Transformer used in ViT.

First, when an image is input, the feature-vector generation unit 2 splits the input image into a preset number (m; the number of patch dimensions) of images. Next, for each of the m split images (patches) obtained by the splitting, the feature-vector generation unit 2 generates a feature vector including a preset number (d; the number of feature amount dimensions) of feature amounts. In other words, the feature-vector generation unit 2 generates an input matrix X₁ (m×d matrix). Note that, for details of the feature-vector generation unit 2, reference is to be made to Reference Document [1].

Next, when the input matrix X₁ generated by the feature-vector generation unit 2 is input thereto, the first transformer processing unit 3₁ executes a transformer process and outputs an output matrix Y₁ (=input matrix X₂ (m×d matrix)). Next, when the input matrix X₂ generated by the transformer processing unit 31 is input thereto, the transformer processing unit 3₂ executes a transformer process and outputs an output matrix Y₂ (=input matrix X₃ (m×d matrix)).

When transformer processes are sequentially executed in such a manner and an input matrix Xₙ generated by the transformer processing unit 3ₙ₋₁ is input to the final transformer processing unit 3ₙ, a transformer process is executed and an output matrix Yₙ (=input matrix Xₙ₊₁ (m×d matrix)) is output.

Next, the determination unit 4 makes a determination based on the input matrix Xₙ₊₁ (m×d matrix) and outputs a determination result (for example, an inference result of object detection, pose estimation, or the like). Note that, for example, the determination unit 4 is a class filter (MLP Head) in which a Multi Layer Perceptron (MLP) is used, or the like.

Next, the transformer processing unit 3 will be described.

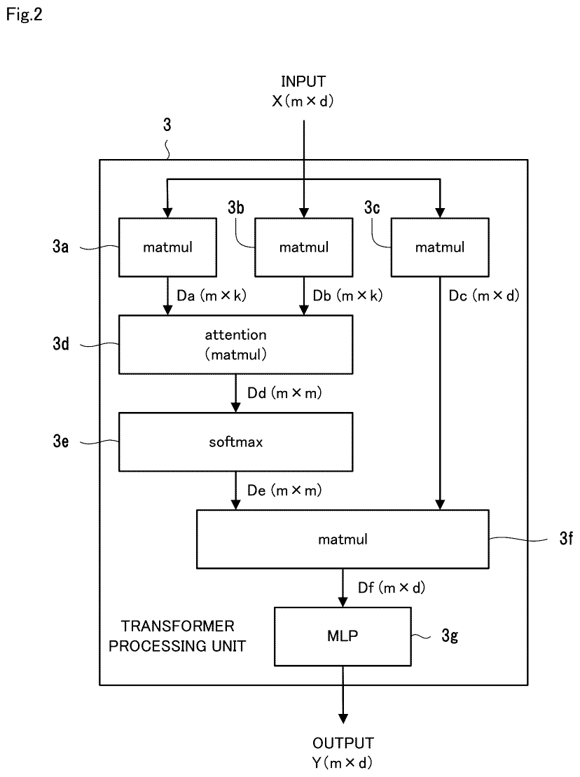

FIG. 2 is a diagram for describing an example of a conventional transformer processing unit. The transformer processing unit 3 (Transformer) illustrated in FIG. 2 includes matmuls (matrix multipliers) 3a, 3b, and 3c, an attention (matrix multiplier) 3d, a softmax 3e, a matmul (matrix multiplier) 3f, and an MLP 3g. Note that the matmuls and the attention described above each execute matrix multiplication computation.

In the transformer processing unit 3 illustrated in FIG. 2, first, an input matrix X (m×d matrix) is input to each of the matmuls 3a, 3b, and 3c. The matmul 3a executes matrix multiplication computation (linear transformation) using the input matrix X (m×d matrix) that is input and a matrix Wa (d×k matrix) of learned weight parameters stored in an unillustrated storage device, and outputs a matrix Da (key (K); m×k matrix). Here, k and d represent the number of feature amounts (number of dimensions) in each patch.

Also, the matmul 3b executes matrix multiplication computation (linear transformation) using the input matrix X (m×d matrix) that is input and a matrix Wb (d×k matrix) of learned weight parameters stored in the above-described storage device, and outputs a matrix Db (query (Q); m×k matrix).

Furthermore, the matmul 3c executes matrix multiplication computation (linear transformation) using the input matrix X (m×d matrix) that is input and a matrix Wc (d×d matrix) of learned weight parameters stored in the above-described storage device, and outputs a matrix Dc (value (V); m×d matrix).

Next, the attention 3d (Attention mechanism) executes matrix multiplication computation (dot product) using the matrix Da (m×k matrix) and the matrix Db (m×k matrix), and outputs a matrix Dd (similarity; m×m matrix).

Next, the softmax 3e applies a softmax function to the matrix Dd (m×m matrix) and calculates a matrix De (importance; m×m matrix). Note that, in each row of the matrix De, the importance of each patch with respect to the other patches is stored.

Next, the matmul 3f executes matrix multiplication computation using the matrix Dc (value (V); m×d matrix) and the matrix Dd (importance; m×m matrix), and outputs a matrix Df (m×d matrix). Next, the MLP 3g outputs an output matrix Y (m×d matrix) using the matrix Df.

However, according to the above-described image processing in which ViT is used, the amount of computation involved in matrix multiplication computation executed by the transformer processing unit 3 is enormous and processing time increases accordingly should high-resolution tasks such as practical object detection and pose estimation be processed, for example.

Through such a process, the inventor found the problem of reducing the amount of computation involved in matrix multiplication computation executed by a transformer processing unit, and also arrived at a means for solving the problem. As a result, the processing time of image processing in which ViT is used can be reduced.

In the following, an example embodiment will be described with reference to the drawings. Note that, in the drawings described in the following, the same reference symbol is provided to elements having the same function or corresponding functions, and repetitive description thereof may be omitted.

### Example Embodiment

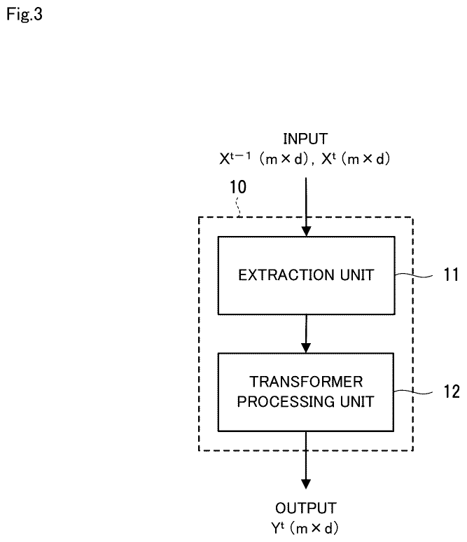

A configuration of a plurality of sparse transformer units included in an image processing apparatus in the example embodiment will be described with reference to FIG. 3. FIG. 3 is a diagram for describing an example of a sparse transformer unit.

### [Apparatus Configuration]

A sparse transformer unit 10 illustrated in FIG. 3 is used to reduce the processing time of image processing in which ViT is used. Furthermore, as illustrated in FIG. 3, the sparse transformer unit 10 includes an extraction unit 11 and a transformer processing unit 12.

The extraction unit 11: uses a matrix (input matrix X^{t} (m×d matrix) formed such that a plurality of first feature vectors input at a first time point t constitute rows and a matrix (input matrix X^{t-1} (m×d matrix) formed such that a plurality of second feature vectors input at a second time point t−1 that is earlier than the first time point t constitute rows to calculate, for each of the first feature vectors, the difference Sub (=|X^{t}−X^{t-1}|) between the first feature vector and a second feature vector corresponding to the first feature vector; and, based on the difference Sub, extracts a feature vector that is a computation target (X′^{t} (m′×d matrix)) from among the first feature vectors.

The transformer processing unit 12 includes a plurality of matrix multipliers that execute matrix multiplication computation using the plurality of first feature vectors (input matrix X^{t} (m×d matrix), wherein each of the matrix multipliers: executes matrix multiplication computation for the feature vector that is a computation target; and does not execute matrix multiplication computation and uses a result of the matrix multiplication computation executed at the second time point t−1 for a feature vector that is not a computation target among the first feature vectors.

In such a manner, in the example embodiment, the amount of computation involved in matrix multiplication computation can be reduced compared to the conventional transformer processing unit 3 because matrix multiplication computation is executed only for one or more feature vectors that are computation targets, and the result of matrix multiplication computation executed at the second time point t−1 is used for feature vectors that are not computation targets. Thus, the processing time of each transformer processing unit can be reduced. Furthermore, because the processing time of the transformer processing units can be reduced, the processing time of the image processing apparatus as a whole can be reduced.

### [System Configuration]

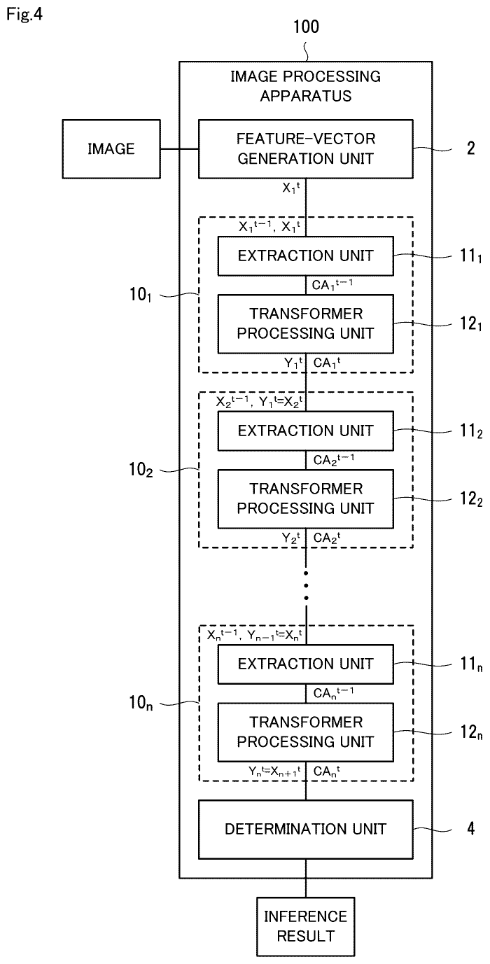

Subsequently, a configuration of the image processing apparatus in the example embodiment will be described in detail with reference to FIG. 4. FIG. 4 is a diagram illustrating an example of a system including the image processing apparatus.

### Image Processing Apparatus

An image processing apparatus 100 includes the feature-vector generation unit 2, sparse transformer units 10 (sparse transformer unit 10₁ (extraction unit 11₁, transformer processing unit 12₁), sparse transformer unit 10₂ (extraction unit 11₂, transformer processing unit 12₂) . . . sparse transformer unit 10ₙ (extraction unit 11ₙ, transformer processing unit 12ₙ), and the determination unit 4. Note that the determination unit 4 has already been described, and description thereof is thus omitted. Furthermore, n is a positive integer of 3 or greater.

Furthermore, for example, the image processing apparatus 100 is a central processing unit (CPU), a programmable device such as a field-programmable gate array (FPGA), a graphics processing unit (GPU), or a circuit or an information processing apparatus such as a server computer, a personal computer, or a mobile terminal having one or more of a CPU, a programmable device, and a GPU installed therein.

Furthermore, during operation, the image processing apparatus 100 acquires information that is stored in an unillustrated storage device and necessary for inference, such as trained parameters and the structure of a neural network. Note that the storage device is a database, a server computer, a circuit including a memory, or the like.

### Feature-Vector Generation Unit

The feature-vector generation unit 2 sequentially acquires images that are input thereto. Next, for each acquired image, the feature-vector generation unit 2 splits the acquired image into a preset number (m) of images. Next, for each of the m (the number of patch dimensions) split images (patches), the feature-vector generation unit 2 generates a feature vector including a preset number (d; number of feature amount dimensions) of feature amounts. That is, the feature-vector generation unit 2 generates an input matrix X₁^{t} (m×d matrix) including m×d elements (feature amounts).

Note that a plurality of feature vectors generated by the feature-vector generation unit 2 at a first time point t are represented as the input matrix X₁^{t} (m×d matrix), and a plurality of feature vectors generated by the feature-vector generation unit 2 at a second time point t−1 are represented as an input matrix X₁^{t-1} (m×d matrix).

### Sparse Transformer Unit

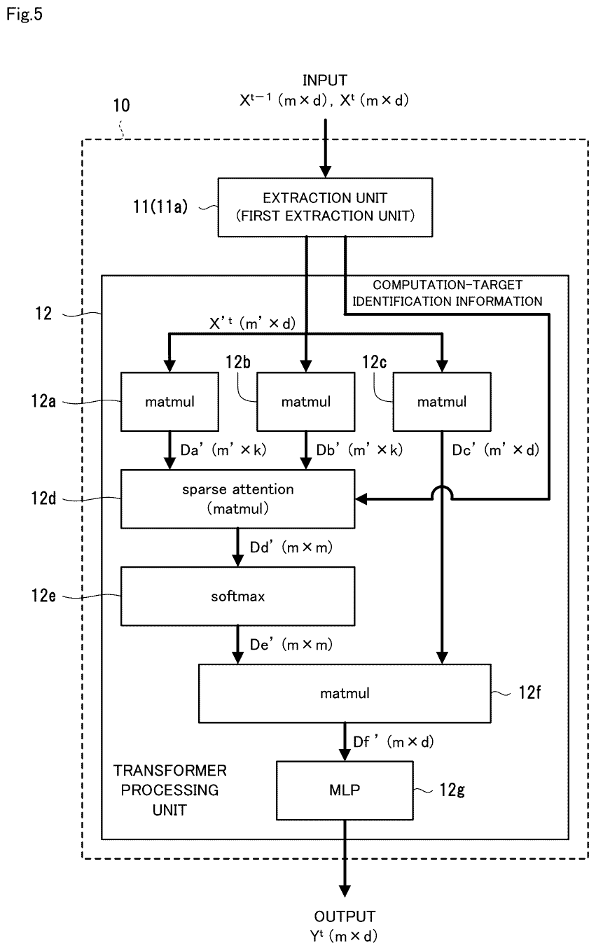

FIG. 5 is a diagram for describing an example of a configuration of a sparse transformer unit. The sparse transformer units 10 each include an extraction unit 11 and a transformer processing unit 12.

### Extraction Unit

By using subsequently described method (1) or (2), the extraction unit 11 reduces the amount of computation involved in matrix multiplication computation by matmuls (matrix multipliers; first computation unit) 12a, 12b, and 12c, and a sparse attention (matrix multiplier) 12d that are included in the transformer processing unit 12 . . . .

### Method (1)

By using method (1), the extraction unit 11 extracts a feature vector that is a computation target (matrix X′^{t} (m′×d matrix)) from the input matrix X^{t} (m×d matrix). Furthermore, the extraction unit 11 outputs, to the transformer processing unit 12, computation-target identification information that includes information indicating a row number of the feature vector that is a computation target in the input matrix X^{t} (m×d matrix). Note that, in the following, the extraction unit 11 may be referred to as a first extraction unit 11a when method (1) is adopted in the extraction unit 11.

### First Extraction Unit 11a

With reference to FIG. 4, first extraction units 11a₁ to 11aₙ will be described.

In the example in FIG. 4, first, the input matrix X₁^{t} (m×d matrix) corresponding to the first time point t and the input matrix X₁^{t-1} (m×d matrix) corresponding to the second time point t−1, which have been generated by the feature-vector generation unit 2, are input to the extraction unit 11₁ (first extraction unit 11a₁). Then, the extraction unit 11₁ (first extraction unit 11a₁) extracts a feature vector that is a computation target (matrix X₁′^{t} (m₁′×d matrix)) from the plurality of first feature vectors (input matrix X₁^{t} (m×d matrix)).

Furthermore, the extraction unit 11₁ (first extraction unit 11a₁) acquires computation-target identification information that indicates a row number of the feature vector that is a computation target in the input matrix X₁^{t} (m×d matrix), and that will be used by the sparse attention 12d.

Next, in the example in FIG. 4, an input matrix X₂^{t} (m×d matrix) corresponding to the first time point t and an input matrix X₂^{t-1} (m×d matrix) corresponding to the second time point t−1 that have been generated by the transformer processing unit 12₁ are input to the extraction unit 11₂. Then, the extraction unit 11₂ (first extraction unit 11a₂) extracts a feature vector that is a computation target (matrix X₂′^{t} (m₂′×d matrix)) from a plurality of first feature vectors (input matrix X₂^{t} (m×d matrix)).

Furthermore, the extraction unit 11₂ (first extraction unit 11a₂) acquires computation-target identification information that indicates a row number of the feature vector that is a computation target in the input matrix X₂^{t} (m×d matrix), and that will be used by the sparse attention 12d.

Next, in the example in FIG. 4, an input matrix Xₙ^{t} (m×d matrix) corresponding to the first time point t and an input matrix Xₙ^{t-1} (m×d matrix) corresponding to the second time point t−1 that have been generated by the transformer processing unit 12ₙ₋₁, are input to the extraction unit 11ₙ. Then, the extraction unit 11ₙ (first extraction unit 11aₙ) extracts a feature vector that is a computation target (matrix Xₙ′^{t} (mₙ′×d matrix)) from a plurality of first feature vectors (input matrix Xₙ^{t} (m×d matrix)).

Furthermore, the extraction unit 11ₙ (first extraction unit 11aₙ) acquires computation-target identification information that indicates a row number of the feature vector that is a computation target in the input matrix Xₙ^{t} (m×d matrix), and that will be used by the sparse attention 12d.

With reference to FIG. 5, an extraction unit 11 (first extraction unit 11a) will be described in detail.

First, the extraction unit 11 (first extraction unit 11a) uses a plurality of first feature vectors (input matrix X^{t} (m×d matrix) input at a first time point t and a plurality of second feature vectors (input matrix X^{t-1} (m×d matrix) input at a second time point t−1 to calculate, for each of the first feature vectors, the difference Sub (=|X^{t}−X^{t-1}|) between the first feature vector and a second feature vector corresponding to the first feature vector. Note that the difference Sub is a matrix.

Next, for each of the first feature vectors in the difference Sub, the extraction unit 11 (first extraction unit 11a) calculates a total sum Sum of feature amounts (elements) included in the first feature vector.

Next, if a calculated total sum Sum is greater than or equal to a preset threshold (first threshold) Th1, the extraction unit 11 (first extraction unit 11a) extracts the first feature vector corresponding to the total sum Sum that is greater than or equal to the threshold Th1 as a feature vector that is a computation target (matrix X′^{t} (m′×d matrix)).

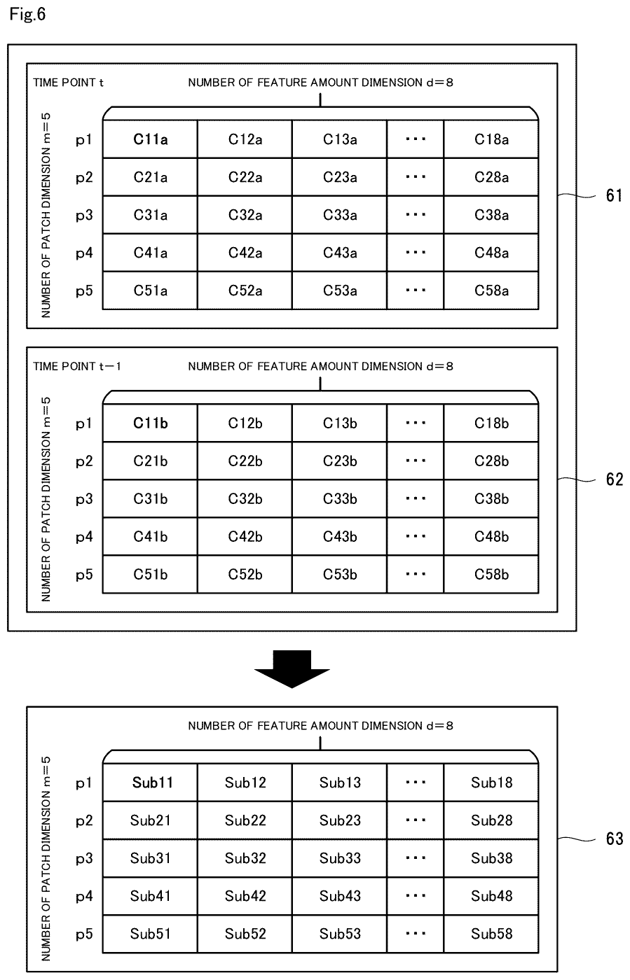

With reference to FIG. 6, the extraction unit 11₁ (first extraction unit 11a₁) will be described in detail.

FIG. 6 is a diagram for describing an example of an extraction unit (method (1)). Table 61 corresponding to the first time point t in FIG. 6 indicates the relationships between first split images (patches; p1, p2, p3, p4, and p5) obtained by the feature-vector generation unit 2 performing splitting into five at the first time point t and first feature vectors (rows) respectively corresponding to the first split images (patches).

Furthermore, table 62 corresponding to the second time point t−1 in FIG. 6 indicates the relationships between second split images (patches; p1, p2, p3, p4, and p5) obtained by the feature-vector generation unit 2 performing splitting into five at the second time point t−1 and second feature vectors (rows) respectively corresponding to the second split images (patches).

Also, in the example in FIG. 6, the five first feature vectors each include eight feature amounts. That is, table 61 corresponding to the first time point t in FIG. 6 represents an input matrix X₁^{t} (5×8 matrix) in which the number of patch dimensions (m) is 5 and the number of feature amount dimensions (d) is 8. Table 62 corresponding to the second time point t−1 in FIG. 6 represents an input matrix X₁^{t-1} (5×8 matrix) in which the number of patch dimensions (m) is 5 and the number of feature amount dimensions (d) is 8.

Table 63 in FIG. 6 represents the difference Sub₁ (=|X₁^{t}−X₁^{t-1}|). The difference Sub₁ is a matrix obtained by calculating a difference value between corresponding feature amounts (elements) of the matrix in table 61 and the matrix in table 62, and determining the absolute value of the calculated difference value. For example, the difference value Sub11 (bolded) in table 63 in FIG. 6 can be calculated as shown in Math. 1.

$$Sub 11 = \vert C 11 a - C 11 b \vert \qquad ( Math . 1 )$$

Next, for each of the rows corresponding to the first split images (patches; p1, p2, p3, p4, and p5) in table 63 (difference Sub₁), the first extraction unit 11a₁ calculates a total sum of elements included in the row (total-sum matrix Sum).

For example, the total sum Sum1 corresponding to patch p1 in table 63 is the total sum of the eight elements (difference values; Sub11, Sub12, Sub13, . . . Sub18) included in the row corresponding to patch p1. For example, the total sum Sum1 corresponding to patch p1 can be calculated as shown in Math. 2.

$$Sum 1 = Sub 11 + Sub 12 + Sub 13 + … + Sub 18 \qquad ( Math . 2 )$$

In such a manner, the first extraction unit 11a₁ calculates the total sums of elements Sum1, Sum2, Sum3, Sum4, and Sum5 for the individual first split images (patches; p1, p2, p3, p4, and p5). Note that the total-sum matrix Sum can be represented as shown in Math. 3.

$$Sum = \{ Sum 1 , Sum 2 , Sum 3 , … , Sum 5 \} \qquad ( Math . 3 )$$

However, the total sums Sum are not limited to the total sums (reduce sums) shown in Math. 2. For example, weighted sums may be used as the total sums Sum.

Next, if total sums Sum for rows corresponding to first split images (patches) are greater than or equal to the preset threshold Th1, the first extraction unit 11a₁ extracts the first split images (patches) that are greater than or equal to the threshold Th1 because it can be judged that there have been changes in the split images (patches) corresponding to the total sums Sum that are greater than or equal to the threshold Th1. For example, the threshold Th1 is determined by experimentation, simulation, etc.

Next, the first extraction unit 11a₁ extracts the first feature vectors (rows) corresponding to the extracted first split images (patches) as feature vectors that are computation targets. That is, because only feature vectors corresponding to first split images (patches) that are computation targets are extracted from the m first feature vectors (rows), the number of dimensions can be reduced (m→m′ (m>m′)).

If there is one split image (patch) that is greater than or equal to the threshold Th1 (e.g., if the computation target is p2), the first feature vector (1×8 matrix) corresponding to p2 at the first time point t in table 61 is extracted. Furthermore, if there are a plurality of split images (patches) that are greater than or equal to the threshold Th1 (e.g., if the computation targets are p2 and p3), the two first feature vectors (2×8 matrix) corresponding to p2 and p3 at the first time point t in table 61 are extracted.

Furthermore, the extraction unit 11a₁ (first extraction unit 11a₁) generates computation-target identification information that includes information indicating the row numbers of the feature vectors that are computation targets in the input matrix X₁^{t} (m×d matrix).

Subsequently, the first extraction unit 11a₁ (first extraction unit 11a₁) outputs the extracted feature vectors that are computation targets (matrix X₁′^{t} (m₁′×d matrix)) to the transformer processing unit 12₁.

Next, the extraction units 11₂ to 11ₙ (first extraction units 11a₂ to 11aₙ) will be described in detail. In the example in FIG. 4, each of the extraction units 11₂ to 11ₙ (first extraction units 11a₂ to 11aₙ) also execute processing as described in regard to the above-described first extraction unit 11a₁ using, as input, an output matrix Y₁^{t} (matrix X₂^{t}), Y₂^{t} (matrix X₃^{t}), . . . Yₙ₋₁^{t} (matrix Xₙ^{t}) corresponding to the first time point t and an output matrix Y₁^{t-1} (matrix X₂^{t-1}), Y₂^{t-1} (matrix X₃^{t-1}), . . . Yₙ₋₁^{t-1} (matrix Xₙ^{t-1}) corresponding to the second time point t−1 that are respectively output from the sparse transformer units 10₁ to 10ₙ₋₁.

In such a manner, each of the extraction units 11₁ to 11ₙ (first extraction units 11a₁ to 11aₙ) extracts a feature vector that is a computation target (matrix X′^{t} (m′×d matrix)) from a plurality of first feature vectors (input matrix X^{t} (m×d matrix)).

Furthermore, the extraction unit 11 (first extraction unit 11a) generates computation-target identification information that includes information indicating a row number, in the input matrix X^{t} (m×d matrix), of the feature vector that is a computation target to be used by the sparse attention 12d.

Subsequently, the extraction unit 11 (first extraction unit 11a) outputs the feature vector that is a computation target (matrix X′^{t} (m′×d matrix)) to the matmuls 12a, 12b, and 12c of the transformer processing unit 12. Furthermore, the extraction unit 11 (first extraction unit 11a) outputs the computation-target identification information to the sparse attention 12d.

### Method (2)

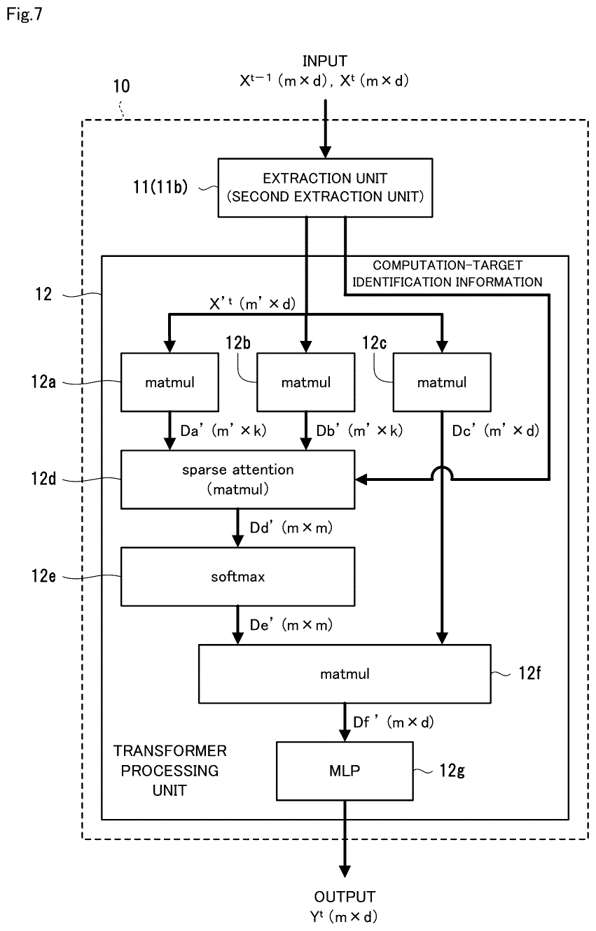

FIG. 7 is a diagram for describing an example of a configuration of a sparse transformer unit. In method (2), as was the case in method (1), the extraction unit 11 extracts a feature vector that is a computation target (matrix X′^{t} (m′×d matrix)) from the input matrix X^{t} (m×d matrix). Specifically, the extraction unit 11 extracts a feature vector that is a computation target (matrix X′^{t} (m′×d matrix)) in order to reduce the amount of computation involved in matrix multiplication computation by the matmuls 12a, 12b, and 12c of the transformer processing unit 12.

Furthermore, the extraction unit 11 in method (2) uses a computation-target extraction matrix to extract computation-target identification information used to reduce the amount of computation involved in matrix multiplication computation by the sparse attention 12d of the transformer processing unit 12.

Note that, in the following, the extraction unit 11 may be referred to as a second extraction unit 11b when method (2) is adopted in the extraction unit 11.

### ·Second Extraction Unit 11b

With reference to FIG. 4, extraction units 11b₁ to 11bₙ will be described.

In the example in FIG. 4, first, the input matrix X₁^{t} (m×d matrix) corresponding to the first time point t and the input matrix X₁^{t-1} (m×d matrix) corresponding to the second time point t−1, which have been generated by the feature-vector generation unit 2, are input to the extraction unit 11₁ (second extraction unit 11b₁). Then, the extraction unit 11₁ (second extraction unit 11b₁) extracts a feature vector that is a computation target (matrix X₁′^{t} (m₁′×d matrix)) from the plurality of first feature vectors (input matrix X₁^{t} (m×d matrix)).

Furthermore, the extraction unit 11₁ (second extraction unit 11b₁) generates computation-target identification information that includes information indicating the positions of computation-target matrix elements in the input matrix X₁^{t} (m×d matrix), and that will be used by the sparse attention 12d.

Next, in the example in FIG. 4, an input matrix X₂^{t} (m×d matrix) corresponding to the first time point t and an input matrix X₂^{t-1} (m×d matrix) corresponding to the second time point t−1 that have been generated by the transformer processing unit 12₁ are input to the extraction unit 11₂. Then, the extraction unit 11₂ (second extraction unit 11b₂) extracts a feature vector that is a computation target (matrix X₂′^{t} (m₂′×d matrix)) from a plurality of first feature vectors (input matrix X₂^{t} (m×d matrix)).

Furthermore, the extraction unit 11₂ (second extraction unit 11b₂ generates computation-target identification information that includes information indicating the positions of computation-target matrix elements in the input matrix X₂^{t} (m×d matrix), and that will be used by the sparse attention 12d.

Next, in the example in FIG. 4, an input matrix Xₙ^{t} (m×d matrix) corresponding to the first time point t and an input matrix Xₙ^{t-1} (m×d matrix) corresponding to the second time point t−1 that have been generated by the transformer processing unit 12ₙ₋₁, are input to the extraction unit 11ₙ. Then, the extraction unit 11ₙ (second extraction unit 11bₙ) extracts a feature vector that is a computation target (matrix Xₙ′^{t} (mₙ′×d matrix)) from a plurality of first feature vectors (input matrix Xₙ^{t} (m×d matrix)).

Furthermore, the extraction unit 11ₙ (second extraction unit 11bₙ) generates computation-target identification information that includes information indicating the positions of computation-target matrix elements in the input matrix Xₙ^{t} (m×d matrix), and that will be used by the sparse attention 12d.

With reference to FIG. 7, an extraction unit 11 (second extraction unit 11b) will be described in detail.

As was the case in method (1), first, the extraction unit 11 (second extraction unit 11b) extracts a feature vector that is a computation target (matrix X′^{t} (m′×d matrix)). Furthermore, the extraction unit 11 (second extraction unit 11b) uses a computation-target extraction matrix to generate computation-target identification information to be used to reduce the amount of computation involved in matrix multiplication computation by the sparse attention 12d of the transformer processing unit 12.

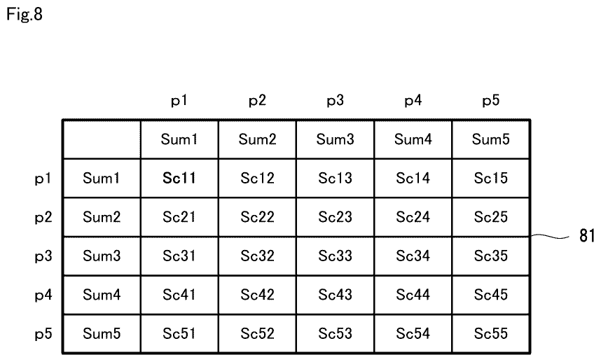

With reference to FIG. 8, the extraction unit 11 (second extraction unit 11b) will be described in detail.

FIG. 8 is a diagram for describing an example of an extraction unit (method (2)). In method (2), first, the extraction unit 11 (second extraction unit 11b) executes matrix multiplication computation (Sum×Sum) using total sums Sum. Table 81 in FIG. 8 shows a result (computation-target extraction matrix) of matrix multiplication computation (Sum×Sum) using total sums Sum.

Next, the extraction unit 11 (second extraction unit 11b) compares each of the elements in the computation-target extraction matrix and a preset threshold (second threshold) Th2, and selects the element as a computation-target element if the element is greater than or equal to the threshold Th2. For example, in the case of the element value Sc11 in table 81, the element position (p1, p1) corresponding to Sc11 is extracted if Sc11 is greater than or equal to the threshold Th2. Conversely, Sc11 is not extracted if Sc11 is smaller than the threshold Th2.

Next, the extraction unit 11 (second extraction unit 11b) generates computation-target identification information that includes information indicating the positions of selected elements, and outputs the computation-target identification information to the sparse attention (matrix multiplier) 12d.

### Transformer Processing Unit

The transformer processing unit 12 includes matmuls (matrix multipliers; first computation unit) 12a, 12b, and 12c, a sparse attention (matrix multiplier) 12d, a softmax 12e, a matmul (matrix multiplier) 12f, and an MLP 12g. Note that the matmuls and the sparse attention described above each execute matrix multiplication computation.

In the transformer processing unit 12 illustrated in FIGS. 5 and 7, first, an input matrix X′^{t} (m′×d matrix) is input to each of the matmuls 12a, 12b, and 12c. The matmul 12a executes matrix multiplication computation (linear transformation) using the input matrix X′^{t} (m′×d matrix) that is input and a matrix Wa (d×k matrix) formed using learned weight parameters stored in the unillustrated storage device, and outputs a matrix Da′ (key (K); m′×k matrix).

Also, the matmul 12b executes matrix multiplication computation (linear transformation) using the input matrix X′^{t} (m′×d matrix) and a matrix Wb (d×k matrix) formed using learned weight parameters stored in the above-described storage device, and outputs a matrix Db′ (query (Q); m′×k matrix).

Furthermore, the matmul 12c executes matrix multiplication computation (linear transformation) using the input matrix X′^{t}(m′×d matrix) and a matrix Wc (d×d matrix) formed using learned weight parameters stored in the above-described storage device, and outputs a matrix Dc′ (value (V); m′×d matrix).

The amount of computation involved in matrix multiplication computation can be reduced because, as described above, each of the matmuls (matrix multipliers; first computation unit) 12a, 12b, and 12c executes matrix multiplication computation using the input matrix X′^{t} (m′×d matrix) obtained by reducing the number of dimensions.

The sparse attention 12d (Attention mechanism; attention processing unit) first acquires the matrix Da′ (m′×k matrix), the matrix Db′ (m′×k matrix), and the computation-target identification information. Next, the sparse attention 12d executes matrix multiplication computation (dot product) using the matrix Da′ (m′×k matrix) and the matrix Db′ (m′×k matrix), and outputs a matrix Dd′ (similarity; m×m matrix). Note that the sparse attention 12d executes matrix multiplication computation based on the computation-target identification information. Here, because the matrix Dd′ is obtained by multiply-accumulate computation between a multiplier vector and a multiplicand vector that are both sparse vectors, the output matrix has m×m dimensions rather than m′×m′ dimensions.

In a case in which the computation-target identification information described in method (1) is acquired, the sparse attention 12d uses elements included in a column and a row indicated by the row number of a feature vector that is a computation target in the input matrix X^{t} (m×d matrix) as computation-target elements in matrix multiplication computation, and executes matrix multiplication computation only for the computation-target elements. Furthermore, the sparse attention 12d does not execute matrix multiplication computation and uses a result of the matrix multiplication computation executed at the second time point t−1 (internal feature amounts; CA^{t-1}) for elements that are not the computation targets.

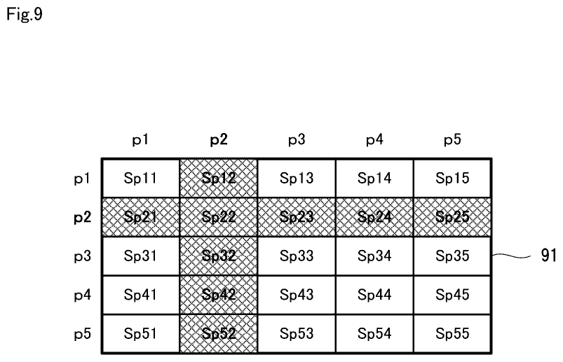

FIG. 9 is a diagram for describing sparse attention in method (1). For example, in a case in which the feature vector row number is p2, matrix multiplication computation is executed only for the elements corresponding to row p2 and column p2 (hatched) corresponding to the row number p2, as illustrated in FIG. 9.

In a case in which the computation-target identification information described in method (2) is acquired, the sparse attention 12d uses an element corresponding to the position of an extracted element as a computation-target element in matrix multiplication computation, and executes matrix multiplication computation only for the computation-target element. Furthermore, the sparse attention 12d does not execute matrix multiplication computation and uses a result of the matrix multiplication computation executed at the second time point t−1 (internal feature amounts; CA^{t-1}) for an element that is not the computation target.

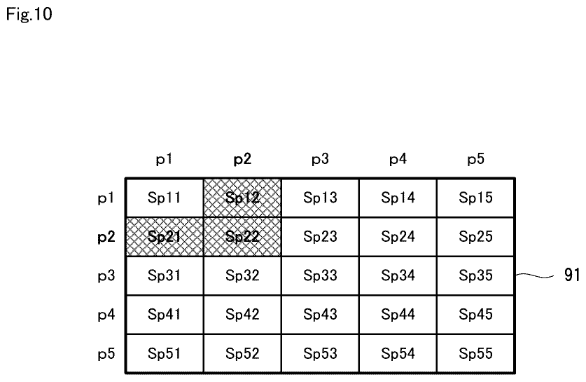

FIG. 10 is a diagram for describing sparse attention in method (2). For example, if the extracted element positions are (p1, p2), (p2, p1), and (p2, p2), matrix multiplication computation is executed only for elements corresponding to (p1, p2), (p2, p1), and (p2, p2) (hatched), as illustrated in FIG. 10.

The softmax 12e applies a softmax function to the matrix Dd′ (m×m matrix) and calculates a matrix De′ (importance; m×m matrix). Note that, in each row of the matrix De′, the importance of each patch with respect to the other patches is stored.

The matmul 12f executes matrix multiplication computation using the matrix Dc′ (value (V); m′×d matrix) and the matrix Dd′ (importance; m×m matrix), and outputs a matrix Df′ (m×d matrix). Next, the MLP 12g outputs an output matrix Y (m×d matrix) using the matrix Df′. Here, because the matrix Dd′ is obtained by multiply-accumulate computation between a multiplier vector and a multiplicand vector that are both sparse vectors, the output matrix has m×m dimensions rather than m′×m′ dimensions.

### [Apparatus Operations]

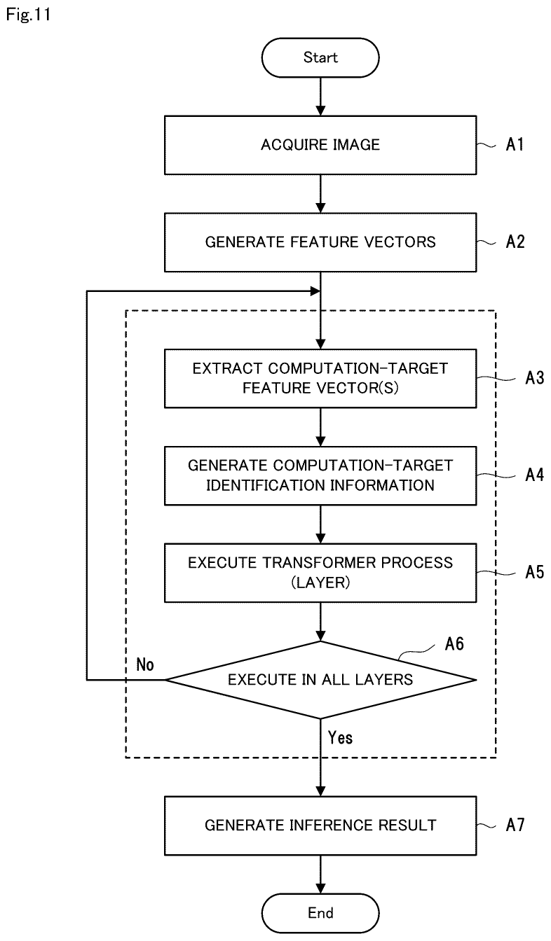

Next, operations of the image processing apparatus in the example embodiment will be described with reference to FIG. 11. FIG. 11 is a diagram for describing the image processing apparatus. Drawings will be referred to as needed in the following description. Furthermore, in the example embodiment, an image processing method is implemented by causing the image processing apparatus to operate. Accordingly, the following description of the operations performed by the image processing apparatus is substituted for the description of the image processing method in the example embodiment.

As illustrated in FIG. 11, first, the feature-vector generation unit 2 sequentially acquires images that are input thereto (step A1). Note that preprocessing (resizing, color conversion, image cropping, rotation, etc.) has been applied to the images.

Next, the feature-vector generation unit 2 splits each image acquired by sequentially acquiring images into a preset number of images, and generates a feature vector for each split image obtained by the splitting (step A2).

Specifically, in step A2, the feature-vector generation unit 2 splits an input image into a preset number (m; the number of patch dimensions) of images. Next in step A2, for each of the m split images (patches) obtained by the splitting, the feature-vector generation unit 2 generates a feature vector including a preset number (d; the number of feature amount dimensions) of feature amounts. In other words, the feature-vector generation unit 2 generates an input matrix X^{t} (m×d matrix).

Next, the extraction unit 11 extracts a feature vector that is a computation target (matrix X′^{t} (m′×d matrix) from the input matrix X^{t} (m×d matrix) (step A3).

Specifically, in step A3, the extraction unit 11: uses a plurality of first feature vectors (input matrix X^{t} (m×d matrix) input at a first time point t and a plurality of second feature vectors (input matrix X^{t-1} (m×d matrix) input at a second time point t−1 to calculate, for each of the first feature vectors, the difference Sub (=|X^{t}−X^{t-1}|) between the first feature vector and a second feature vector corresponding to the first feature vector; and, based on the difference Sub, extracts a feature vector that is a computation target (X′t (m′×d matrix)) from among the first feature vectors.

Next in step A3, for each of the first feature vectors in the difference Sub, the extraction unit 11 (first extraction unit 11a) calculates a total sum Sum of feature amounts (elements) included in the first feature vector.

Next in step A3, if a calculated total sum Sum is greater than or equal to a preset threshold Th1, the extraction unit 11 (first extraction unit 11a) extracts the first feature vector corresponding to the total sum Sum that is greater than or equal to the threshold Th1 as a feature vector that is a computation target (X′^{t} (m′×d matrix)).

Next, the extraction unit 11 generates computation-target identification information (step A4). Specifically, in step A4, the extraction unit 11 generates computation-target identification information according to above-described method (1) or (2).

In the case of method (1), as described above, the extraction unit 11 (first extraction unit 11a) generates computation-target identification information that includes information indicating a row number, in the input matrix X^{t} (m×d matrix), of the feature vector that is a computation target to be used by the sparse attention 12d.

In the case of method (2), as described above, the extraction unit 11 (second extraction unit 11b generates computation-target identification information that includes information indicating the positions, in the input matrix X^{t} (m×d matrix), of computation-target matrix elements to be used by the sparse attention 12d.

The transformer processing unit 12 executes a transformer process (layer) (step A5). Specifically, in step A5, first, the input matrix X′^{t} (m′×d matrix) is input to each of the matmuls 12a, 12b, and 12c in the transformer processing unit 12.

Next, the matmul 12a executes matrix multiplication computation (linear transformation) using the input matrix X′^{t} (m′×d matrix) that is input and a matrix Wa (d×k matrix) formed using learned weight parameters stored in the unillustrated storage device, and outputs a matrix Da′ (key (K); m′×k matrix).

Also, the matmul 12b executes matrix multiplication computation (linear transformation) using the input matrix X′^{t} (m′×d matrix) and a matrix Wb (d×k matrix) formed using learned weight parameters stored in the above-described storage device, and outputs a matrix Db′ (query (Q); m′×k matrix).

Furthermore, the matmul 12c executes matrix multiplication computation (linear transformation) using the input matrix X′^{t} (m′×d matrix) and a matrix Wc (d×d matrix) formed using learned weight parameters stored in the above-described storage device, and outputs a matrix Dc′ (value (V); m′×d matrix).

Furthermore, the sparse attention 12d (Attention mechanism) first acquires the matrix Da′ (m′×k matrix), the matrix Db′ (m′×k matrix), and the computation-target identification information. Next, the sparse attention 12d executes matrix multiplication computation (dot product) using the matrix Da′ (m′×k matrix) and the matrix Db′ (m′×k matrix), and outputs a matrix Dd′ (similarity; m×m matrix). Note that the sparse attention 12d executes matrix multiplication computation based on the computation-target identification information. Here, because the matrix Dd′ is obtained by multiply-accumulate computation between a multiplier vector and a multiplicand vector that are both sparse vectors, the output matrix has m×m dimensions rather than m′×m′ dimensions.

In a case in which the computation-target identification information described in method (1) is acquired, the sparse attention 12d, based on the row number of the feature vector that is a computation target in the input matrix X^{t} (m×d matrix), executes matrix multiplication computation involving only the elements in a column and a row corresponding to the row number. Furthermore, the sparse attention 12d does not execute matrix multiplication computation and uses a result of the matrix multiplication computation executed at the second time point t−1 (internal feature amounts; CA^{t-1}) for elements that are not the computation targets. Note that the result of matrix multiplication computation executed at the first time point t (internal feature amounts; CA^{t}) is stored in the storage device.

In a case in which the computation-target identification information described in method (2) is acquired, the sparse attention 12d executes matrix multiplication computation involving only elements corresponding to extracted element positions. Furthermore, the sparse attention 12d does not execute matrix multiplication computation and uses a result of the matrix multiplication computation executed at the second time point t−1 (internal feature amounts; CA^{t-1}) for an element that is not the computation target. Note that the result of matrix multiplication computation executed at the first time point t (internal feature amounts; CA^{t}) is stored in the storage device.

The softmax 12e applies a softmax function to the matrix Dd′ (m×m matrix) and calculates a matrix De′ (importance; m×m matrix). Note that, in each row of the matrix De′, the importance of each patch with respect to the other patches is stored.

The matmul 12f executes matrix multiplication computation using the matrix Dc′ (value (V); m′×d matrix) and the matrix Dd′ (importance; m×m matrix), and outputs a matrix Df′ (m×d matrix). Next, the MLP 12g outputs an output matrix Y (m×d matrix) using the matrix Df′.

Next, in a case in which all sparse transformer units 10 (layers) included in the image processing apparatus 100 have been executed (step A6: Yes), the determination unit 4 performs determination based on the input matrix Xₙ₊₁ (m×d matrix) and outputs a determination result (for example, an inference result of object detection, pose estimation, or the like).

Furthermore, in a case in which not all of the sparse transformer units 10 (layers) have been executed (step A6: No), processing transitions to step A3 and processing from step A3 to step A5 is executed.

### Effects of Embodiment

As described above, according to the example embodiment, the amount of computation involved in matrix multiplication computation can be reduced compared to the conventional transformer processing unit because matrix multiplication computation is executed only for one or more feature vectors that are computation targets, and the result of matrix multiplication computation executed at the second time point t−1 is used for the feature vectors that are not computation targets. Thus, the processing time of each transformer processing unit can be reduced. Furthermore, because the processing time of the transformer processing units can be reduced, the processing time of the image processing apparatus as a whole can be reduced.

Note that, while transformer processing units have been described in the example embodiment, the technique of the example embodiment is not limited to being applied to transformer processing units. Furthermore, softmax may be replaced with a different function, and modifications may be made in regard to the specific ones of K, Q, and V for which attention is to be calculated, etc.

### [Program]

The program according to the example embodiment may be a program that causes a computer to execute steps A1 to A7 shown in FIG. 11. By installing this program in a computer and executing the program, the image processing apparatus and the image processing method according to the example embodiment can be realized. Further, the processor of the computer performs processing to function as the feature-vector generation unit 2, the plurality of sparse transformer unit 10 (the extraction unit 11 and a transformer processing unit 12), and the determination unit 4.

Also, the program according to the example embodiment may be executed by a computer system constructed by a plurality of computers. In this case, for example, each computer may function as any of the feature-vector generation unit 2, the plurality of sparse transformer unit 10 (the extraction unit 11 and a transformer processing unit 12), and the determination unit 4.

### [Physical Configuration]

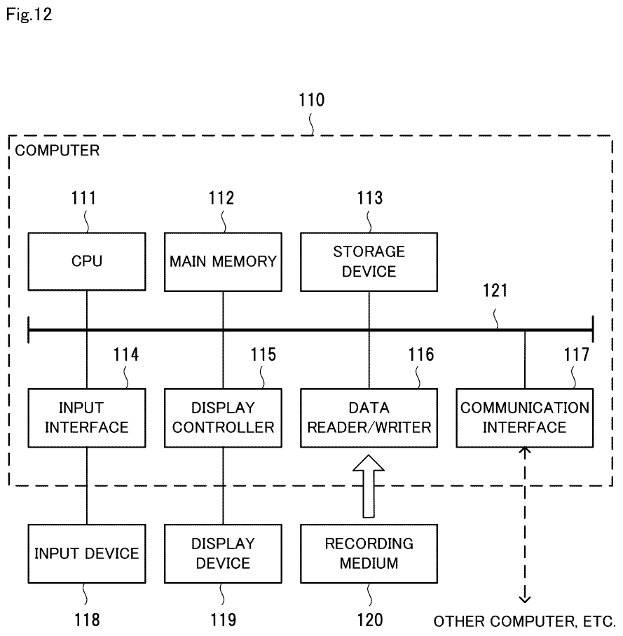

Here, a computer that realizes the image processing apparatus by executing the program according to the example embodiment will be described with reference to FIG. 12. FIG. 12 is a diagram for describing an example of a computer that realizes the image processing apparatus in the example embodiment.

As shown in FIG. 12, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU111 or instead of the CPU111.

The CPU111 loads a program (codes) according to the example embodiments stored in the storage device 113 to the main memory 112, and executes them in a predetermined order to perform various kinds of calculations. The main memory 112 is typically a volatile storage device such as a DRAM (Dynamic Random Access Memory).

Also, the program according to the example embodiment is provided in the state of being stored in a computer-readable recording medium 120. Note that the program according to the example embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The image processing apparatus 100 according to the example embodiment can also be achieved using hardware corresponding to the components, instead of a computer in which a program is installed. Furthermore, a part of the image processing apparatus 100 may be realized by a program and the remaining part may be realized by hardware. In the example embodiments, the computer is not limited to the computer shown in FIG. 12.

### [Supplementary Note]

Furthermore, the following supplementary notes are disclosed regarding the example embodiment described above. Some portion or all of the example embodiment described above can be realized according to (supplementary note 1) to (supplementary note 24) described below, but the below description does not limit the present invention.

### (Supplementary Note 1)

An image processing apparatus comprising a plurality of sparse transformer units,
wherein the sparse transformer units each comprise:
   an extraction unit that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
   a transformer processing unit that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

### (Supplementary Note 2)

The image processing apparatus according to Supplementary note 1 further comprising
a feature-vector generation unit that sequentially acquires images, splits each of the acquired images into a preset number of images, and generates a feature vector for each split image obtained by the splitting.

### (Supplementary Note 3)

The image processing apparatus according to Supplementary note 2,
wherein the extraction unit:
   uses the first feature vectors corresponding to first split images generated by splitting a first image acquired at the first time point and the second feature vectors corresponding to second split images generated by splitting a second image acquired at the second time point to calculate, as the difference for each of the first feature vectors, an absolute value of a difference value between the first feature vector and the second feature vector corresponding to the second split image at the same position as the first split image corresponding to the first feature vector; and
   for each of the first feature vectors, calculates a total sum of feature amounts included in the first feature vector, and, if a calculated total sum is greater than or equal to a preset first threshold, extracts the first feature vector corresponding to the total sum that is greater than or equal to the first threshold as a feature vector that is a computation target.

### (Supplementary Note 4)

The image processing apparatus according to Supplementary note 1,
wherein the transformer processing unit includes a first computation unit, and
each of a plurality of matrix multipliers included in the first computation unit executes matrix multiplication computation using a matrix formed by the feature vector that is a computation target and a matrix formed using weight parameters obtained in advance by learning.

### (Supplementary Note 5)

The image processing apparatus according to Supplementary note 1,
wherein the extraction unit further
   generates computation-target identification information that includes information indicating a row number of the feature vector that is a computation target.

### (Supplementary Note 6)

The image processing apparatus according to Supplementary note 5,
wherein the transformer processing unit includes an attention processing unit, and
a matrix multiplier included in the attention processing unit, upon executing matrix multiplication computation: uses elements included in a column and a row indicated by the row number of the feature vector that is a computation target as elements that are computation targets in the matrix multiplication computation; executes matrix multiplication computation only for the elements that are computation targets; and does not execute the matrix multiplication computation and uses a result of the matrix multiplication computation at the second time point for elements that are not the computation targets.

### (Supplementary Note 7)

The image processing apparatus according to Supplementary note 3,
wherein the extraction unit further:
   generates a computation-target extraction matrix by executing accumulative computation using the feature vector that is a computation target; and, if an element in the computation-target extraction matrix is greater than or equal to a preset second threshold, selects the element that is greater than or equal to the second threshold and generates computation-target identification information that includes information indicating the position of the selected element in the computation-target extraction matrix.

### (Supplementary Note 8)

The image processing apparatus according to Supplementary note 7,
wherein the transformer processing unit includes an attention processing unit, and
a matrix multiplier included in the attention processing unit, upon executing matrix multiplication computation: uses an element corresponding to the position of the selected element as an element that is a computation target in the matrix multiplication computation; executes matrix multiplication computation only for the element that is a configuration target; and does not execute the matrix multiplication computation and uses a result of the matrix multiplication computation at the second time point for an element that is not the computation target.

### (Supplementary Note 9)

An image processing method in which an image processing apparatus executes a plurality of sparse transformer processes,
wherein the sparse transformer processes each execute:
   an extraction process that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
   a transformer process that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

### (Supplementary Note 10)

The image processing method according to Supplementary note 9,
wherein the image processing apparatus further
   sequentially acquires images, splits each of the acquired images into a preset number of images, and generates a feature vector for each split image obtained by the splitting.

### (Supplementary Note 11)

The image processing method according to Supplementary note 10,
wherein the extraction process:
   uses the first feature vectors corresponding to first split images generated by splitting a first image acquired at the first time point and the second feature vectors corresponding to second split images generated by splitting a second image acquired at the second time point to calculate, as the difference for each of the first feature vectors, an absolute value of a difference value between the first feature vector and the second feature vector corresponding to the second split image at the same position as the first split image corresponding to the first feature vector; and
   for each of the first feature vectors, calculates a total sum of feature amounts included in the first feature vector, and, if a calculated total sum is greater than or equal to a preset first threshold, extracts the first feature vector corresponding to the total sum that is greater than or equal to the first threshold as a feature vector that is a computation target.

### (Supplementary Note 12)

The image processing method according to Supplementary note 9,
wherein the transformer process includes a first computation process, and
each of a plurality of matrix multiplication computations executed by the first computation process executes matrix multiplication computation using a matrix formed by the feature vector that is a computation target and a matrix formed using weight parameters obtained in advance by learning.

### (Supplementary Note 13)

The image processing method according to Supplementary note 9,
wherein the extraction process further
   generates computation-target identification information that includes information indicating a row number of the feature vector that is a computation target.

### (Supplementary Note 14)

The image processing method according to Supplementary note 13,
wherein the transformer process includes an attention process, and
the attention process, upon executing matrix multiplication computation: uses elements included in a column and a row indicated by the row number of the feature vector that is a computation target as elements that are computation targets in the matrix multiplication computation; executes matrix multiplication computation only for the elements that are computation targets; and does not execute the matrix multiplication computation and uses a result of the matrix multiplication computation at the second time point for elements that are not the computation targets.

### (Supplementary Note 15)

The image processing method according to Supplementary note 11,
wherein the extraction process further
   generates a computation-target extraction matrix by executing accumulative computation using the feature vector that is a computation target; and, if an element in the computation-target extraction matrix is greater than or equal to a preset second threshold, selects the element that is greater than or equal to the second threshold and generates computation-target identification information that includes information indicating the position of the selected element in the computation-target extraction matrix.

### (Supplementary Note 16)

The image processing method according to Supplementary note 15,
wherein the transformer process includes an attention process, and
the attention process, upon executing matrix multiplication computation: uses an element corresponding to the position of the selected element as an element that is a computation target in the matrix multiplication computation; executes matrix multiplication computation only for the element that is a configuration target; and does not execute the matrix multiplication computation and uses a result of the matrix multiplication computation at the second time point for an element that is not the computation target.

### (Supplementary Note 17)

A computer readable recording medium that includes a program recorded thereon,
wherein the program causes a computer to execute a plurality of sparse transformer processes, and
the sparse transformer processes each execute:
   an extraction process that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
   a transformer process that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

### (Supplementary Note 18)

The computer readable recording medium according to Supplementary note 17,
wherein the program causes the computer to further
   sequentially acquire images, split each of the acquired images into a preset number of images, and generate a feature vector for each split image obtained by the splitting.

### (Supplementary Note 19)

The computer readable recording medium according to Supplementary note 18,
wherein the extraction process
   uses the first feature vectors corresponding to first split images generated by splitting a first image acquired at the first time point and the second feature vectors corresponding to second split images generated by splitting a second image acquired at the second time point to calculate, as the difference for each of the first feature vectors, an absolute value of a difference value between the first feature vector and the second feature vector corresponding to the second split image at the same position as the first split image corresponding to the first feature vector; and
   for each of the first feature vectors, calculates a total sum of feature amounts included in the first feature vector, and, if a calculated total sum is greater than or equal to a preset first threshold, extracts the first feature vector corresponding to the total sum that is greater than or equal to the first threshold as a feature vector that is a computation target.

### (Supplementary Note 20)

The computer readable recording medium according to Supplementary note 17,
wherein the transformer process includes a first computation process, and
each of a plurality of matrix multiplication computations executed by the first computation process executes matrix multiplication computation using a matrix formed by the feature vector that is a computation target and a matrix formed using weight parameters obtained in advance by learning.

### (Supplementary Note 21)

The computer readable recording medium according to Supplementary note 17,
wherein the extraction process further
   generates computation-target identification information that includes information indicating a row number of the feature vector that is a computation target.

### (Supplementary Note 22)

The computer readable recording medium according to Supplementary note 21,
wherein the transformer process includes an attention process, and
the attention process, upon executing matrix multiplication computation: uses elements included in a column and a row indicated by the row number of the feature vector that is a computation target as elements that are computation targets in the matrix multiplication computation; executes matrix multiplication computation only for the elements that are computation targets; and does not execute the matrix multiplication computation and uses a result of the matrix multiplication computation at the second time point for elements that are not the computation targets.

### (Supplementary Note 23)

The computer readable recording medium according to Supplementary note 19,
wherein the extraction process further
   generates a computation-target extraction matrix by executing accumulative computation using the feature vector that is a computation target; and, if an element in the computation-target extraction matrix is greater than or equal to a preset second threshold, selects the element that is greater than or equal to the second threshold and generates computation-target identification information that includes information indicating the position of the selected element in the computation-target extraction matrix.

### (Supplementary Note 24)

The computer readable recording medium according to Supplementary note 23,
wherein the transformer process includes an attention process, and
the attention process, upon executing matrix multiplication computation: uses an element corresponding to the position of the selected element as an element that is a computation target in the matrix multiplication computation; executes matrix multiplication computation only for the element that is a configuration target; and does not execute the matrix multiplication computation and uses a result of the matrix multiplication computation at the second time point for an element that is not the computation target.

While the invention has been described above with reference to an example embodiment thereof, the invention is not limited to the above-described example embodiment. It will be understood by those of ordinary skill in the art that various changes in form and details may be made therein without departing from the scope of the invention.

According to the above description, it is possible to it is reduce the processing time of image processing in which ViT is used. In addition, it is useful in a field where processing using Transformer is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An image processing apparatus comprising a plurality of sparse transformer units,
wherein the sparse transformer units each comprise:
an extraction unit that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
a transformer processing unit that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

2. The image processing apparatus according to claim 1 further comprising
a feature-vector generation unit that sequentially acquires images, splits each of the acquired images into a preset number of images, and generates a feature vector for each split image obtained by the splitting.

3. The image processing apparatus according to claim 2,
wherein the extraction unit:
uses the first feature vectors corresponding to first split images generated by splitting a first image acquired at the first time point and the second feature vectors corresponding to second split images generated by splitting a second image acquired at the second time point to calculate, as the difference for each of the first feature vectors, an absolute value of a difference value between the first feature vector and the second feature vector corresponding to the second split image at the same position as the first split image corresponding to the first feature vector; and
for each of the first feature vectors, calculates a total sum of feature amounts included in the first feature vector, and, if a calculated total sum is greater than or equal to a preset first threshold, extracts the first feature vector corresponding to the total sum that is greater than or equal to the first threshold as a feature vector that is a computation target.

4. The image processing apparatus according to claim 1,
wherein the transformer processing unit includes a first computation unit, and
each of a plurality of matrix multipliers included in the first computation unit executes matrix multiplication computation using a matrix formed by the feature vector that is a computation target and a matrix formed using weight parameters obtained in advance by learning.

5. The image processing apparatus according to claim 1,
wherein the extraction unit further
generates computation-target identification information that includes information indicating a row number of the feature vector that is a computation target.

6. The image processing apparatus according to claim 5,
wherein the transformer processing unit includes an attention processing unit, and
a matrix multiplier included in the attention processing unit, upon executing matrix multiplication computation: uses elements included in a column and a row indicated by the row number of the feature vector that is a computation target as elements that are computation targets in the matrix multiplication computation; executes matrix multiplication computation only for the elements that are computation targets; and does not execute the matrix multiplication computation and uses a result of the matrix multiplication computation at the second time point for elements that are not the computation targets.

7. The image processing apparatus according to claim 3,
wherein the extraction unit further:
generates a computation-target extraction matrix by executing accumulative computation using the feature vector that is a computation target; and, if an element in the computation-target extraction matrix is greater than or equal to a preset second threshold, selects the element that is greater than or equal to the second threshold and generates computation-target identification information that includes information indicating the position of the selected element in the computation-target extraction matrix.

8. The image processing apparatus according to claim 7,
wherein the transformer processing unit includes an attention processing unit, and
a matrix multiplier included in the attention processing unit, upon executing matrix multiplication computation: uses an element corresponding to the position of the selected element as an element that is a computation target in the matrix multiplication computation; executes matrix multiplication computation only for the element that is a configuration target; and does not execute the matrix multiplication computation and uses a result of the matrix multiplication computation at the second time point for an element that is not the computation target.

9. An image processing method in which an image processing apparatus executes a plurality of sparse transformer processes,
wherein the sparse transformer processes each execute:
an extraction process that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
a transformer process that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.

10. A non-transitory computer readable recording medium that includes a program recorded thereon,
wherein the program causes a computer to execute a plurality of sparse transformer processes, and
the sparse transformer processes each execute:
an extraction process that: uses a matrix formed such that a plurality of first feature vectors at a first time point constitute rows and a matrix formed such that a plurality of second feature vectors at a second time point that is earlier than the first time point constitute rows to calculate, for each of the first feature vectors, the difference between the first feature vector and a second feature vector corresponding to the first feature vector; and, based on the difference, extracts a feature vector that is a computation target from among the first feature vectors; and
a transformer process that includes a plurality of matrix multipliers that execute matrix multiplication computation using the plurality of first feature vectors, wherein each of the matrix multipliers: executes matrix multiplication computation for the feature vector that is a computation target; and does not execute matrix multiplication computation and uses a result of the matrix multiplication computation at the second time point for a feature vector that is not a computation target among the first feature vectors.
